(19) United States
(12) Patent Application Publication
(10) Pub. No.: US 2024/0333205 A1
(43) Pub. Date: Oct. 3, 2024

(54) SOLAR PANEL MOUNT DEVICE

(71) Applicants: Justin Hicken, Spanish Fork, UT (US); Wesley Raymond Stirk, Provo, UT (US)

(72) Inventors: Justin Hicken, Spanish Fork, UT (US); Wesley Raymond Stirk, Provo, UT (US)

(21) Appl. No.: 18/622,830

(22) Filed: Mar. 29, 2024

Related U.S. Application Data
(60) Provisional application No. 63/493,275, filed on Mar. 30, 2023.

(51) Int. Cl. H02S 20/32; H02S 30/10

(52) U.S. Cl. CPC H02S 20/32; H02S 30/10

(57) ABSTRACT

A solar panel mount. The solar panel mount includes a base frame and one or more pivots attached to the base frame. The solar panel mount also includes an inner frame, where the inner frame is attached the one or more pivots and a drive, where the drive is configured to tilt the inner frame relative to the base frame.

### CROSS-REFERENCE TO RELATED APPLICATIONS

This application claims the benefit of and priority to U.S. Provisional Patent Application Ser. No. 63/493,275 filed on Mar. 30, 2023, which application is incorporated herein by reference in its entirety.

### BACKGROUND OF THE INVENTION

Many solar panel mounts suffer from the drawback that they hold the solar panel in a stationary position. That is, the mount doesn't move so the solar panel remains in a single position. This means that there is no time, or only a short time, when the solar panel is oriented in the optimal position for electricity production.

In addition, this creates a danger for the solar panel, in that the panel is subject to wind damage. I.e., some mounts position the solar panel in a position that is not parallel to the ground or other surface where the solar panel is located. This allows the solar panel to be positioned to produce more electricity. However, that means that the solar panel is exposed to wind shear. High winds can then damage the solar panel and flying debris is more likely to make contact with the solar panel.

Other mounts move the solar panel trying to place the solar panel for optimum energy production. This likewise exposes the solar panel to wind damage. In fact, the potential for wind damage is higher because the solar panel will be in many positions, one of which will increase wind exposure.

In addition, these mounts are complex. For example, when a panel moves the solar panel in at least two dimensions, this creates a far more complex mechanism required to move the panel than just having two motors. The complexity increases exponentially as the ability to move in different directions increases linearly. In addition, these mechanisms require a sensor of some sort to determine the optimal position of the solar panel and the sensor must be running constantly to maximize electricity production. This creates far more potential problems and the problems often swamp the benefits.

Accordingly, there is a need in the art for a solar panel mount which can allow for changes to the solar panel orientation which will maximize electricity output without an overly complex mechanism. In addition, there is a need in the art for the mount to protect the solar panel from wind damage and/or blowing debris.

### SUMMARY OF THE INVENTION

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a solar panel mount. The solar panel mount includes a base frame and one or more pivots attached to the base frame. The solar panel mount also includes an inner frame, where the inner frame is attached the one or more pivots and a drive, where the drive is configured to tilt the inner frame relative to the base frame.

Another example includes a solar panel mount. The solar panel mount includes a base frame. The base frame includes a casing, where the casing is approximately rectangular in shape and one or more mounting holes in the casing, the mounting holes configured to accept a fastener. The base frame also includes a driver coupler, where the drive coupler creates a point of attachment for a drive and one or more pivots attached to the base frame. The solar panel mount also includes an inner frame. The inner frame is attached the one or more pivots at a hinge point. The inner frame includes a casing, where the casing is approximately rectangular in shape and a drive attachment, where the drive attachment creates a point of attachment for the drive. The solar panel mount further includes the drive. The drive is configured to tilt the inner frame relative to the base frame and attached to the base frame at the drive coupler. The drive is also attached to the inner frame at the drive attachment.

Another example embodiment includes a method for maximizing solar energy production by using a solar panel mount. The method includes aligning a solar panel mount, where aligning a solar panel mount includes positioning the solar panel mount within the path of the sun through the sky. The method also includes attaching the solar panel mount to a surface and tilting the solar panel during daylight hours. The method further includes determining if the wind is over a threshold amount. The method additionally includes keeping the solar panel tilted if the wind is not over the threshold amount and lowering the solar panel if the wind is above the threshold amount.

These and other objects and features of the present invention will become more fully apparent from the following description and appended claims, or may be learned by the practice of the invention as set forth hereinafter.

### BRIEF DESCRIPTION OF DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates the example of a solar panel mount in a raised position;

FIG. 1B illustrates the example of a solar panel mount in a flat position;

FIG. 2 illustrates an example of a base frame;

FIG. 3 illustrates an example of an inner frame; and

FIG. 4 is a flow chart illustrating a method of maximizing solar energy production through the use of a solar panel mount.

### DETAILED DESCRIPTION OF THE INVENTION

Reference will now be made to the figures wherein like structures will be provided with like reference designations. It is understood that the figures are diagrammatic and schematic representations of some embodiments of the invention, and are not limiting of the present invention, nor are they necessarily drawn to scale.

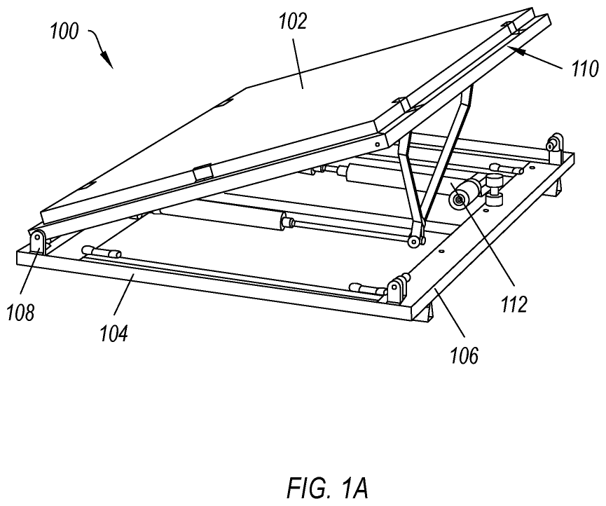

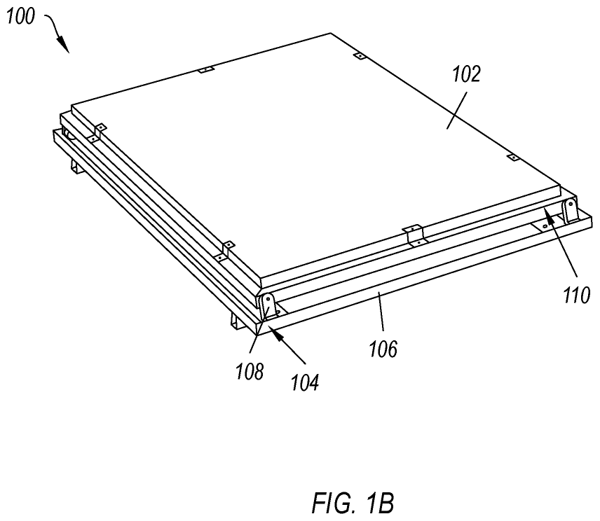

FIGS. 1A and 1B (collectively “FIG. 1”) illustrate an example of a solar panel mount 100. FIG. 1A illustrates the example of a solar panel mount 100 in a raised position; and FIG. 1B illustrates the example of a solar panel mount 100 in a flat position. The solar panel mount 100 is configured to receive and secure a solar panel 102. I.e., the solar panel mount 100 is attached to a surface and in turn has a solar panel 102 attached to it. This creates a connection between the solar panel 102 and the surface via the solar panel mount 100.

FIG. 1 shows that the solar panel mount 100 can include a base frame 104. The base frame 104 serves to secure the solar panel mount 100 to a suitable surface, such as a rooftop, residential rooftop solar racking, a frame on the ground, etc. The closer the base frame 104 is to the surface, the better as it reduces the amount of wind which can be between the solar panel mount 100 and the surface. The base frame 104 is stationary relative to the surface on which it is mounted.

The base frame 104 can include a welded assembly of aluminum framing components 106 and a set of machined pivot and alignment fittings 108 that are welded to the frame. The pivots and alignment fittings 108 allow other components to move relative to the base frame 104. I.e., the pivots and alignment fittings 108 can act as a hinge point about which other components move. For example, the pivots and alignment fittings 108 can include a pin which is inserted into a hole on other parts as described below.

FIG. 1 also shows that the solar panel mount 100 can include an inner frame 110. The inner frame 110 attaches to the base frame 104 at the pivot and alignment fittings 108. This allows the inner frame 110 to move in a single dimension relative to the base frame 104. This has the benefit of allowing the solar panel 102 to be raised to increase electricity production but lowered when needed to minimize wind exposure.

FIG. 1 further shows that the solar panel mount 100 can include a drive 112. The drive 112 is configured to tilt the inner frame 110 relative to the base frame 104 using the pivots and alignment fittings 108 as hinge points. The drive 112 can include any desired mechanism, such as lead screws, ball screws, transmissions, transfer gears, worm drives, linear actuators, and cable reel and pulley systems. One of skill in the art will appreciate that the drive 112 may be paired with a linkage system. In addition, the drive 112 may or may not be spring assisted. These springs can include coil springs, linear springs, and/or gas springs. The solar panel mount 100 can include two drives 112, the first to tilt the solar panel 102 in a first direction and the second to tilt the solar panel 102 in a second direction. I.e., the inner frame 110 can be tilted relative to opposite sides of the base frame 104 by drives 112 on opposite sides of the base frame 104.

As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. Thus, the phrase “configured to” reaches well beyond merely describing functional language or intended use since the phrase actively recites an actual state of configuration.

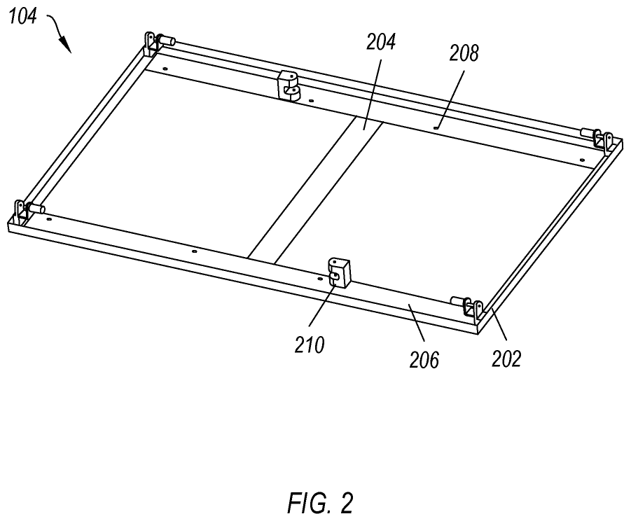

FIG. 2 illustrates an example of a base frame 104. The base frame 104 primarily serves to attach to a surface, such as a roof or ground mount. In addition, the base frame 104 acts as a platform to which an inner frame and/or solar panel can be mounted. Further, the base frame 104 acts as a point from which the inner frame and/or solar panel can be raised. I.e., a drive can push against the base frame 104 in order to raise the inner frame and/or solar panel.

FIG. 2 shows that the base frame 104 can include a casing 202. The casing 202 can be rectangular or approximately rectangular (i.e., parallel sides but with corners that may be rounded or cutoff) but can also be other shapes if needed to match the shape of the solar panel. The casing 202 needs to be strong but light in order to reduce the weight of the solar panel mount while being able to withstand external forces such as wind and the forces involved in tilting the panel which would tend to deform the casing 202.

FIG. 2 also shows that the base frame 104 can include a brace 204. The brace 204 can prevent deformation of the casing 202 during operation of the drive. I.e., the drive pushes against the casing 202 while tilting the solar panel, which may warp the casing 202 over time. The brace 204 provides a counter force to prevent warping. The brace 204 can include an aluminum or other metal strut which connects to opposite sides of the casing 202.

FIG. 2 further shows that the base frame 104 can include slotted bars 206 which contain mounting holes 208 to install fasteners that are to be driven into the roof surface (shingles, underlayment, etc.). The slotted bars 206 can be opposite sides of the casing 202 and can be connected to one another by the brace 204, can be on all sides of the casing 202, and can even be on the brace 204. Thus, deformation can be prevented both by fasteners driven through the mounting holes 208 and the brace 204.

FIG. 2 additionally shows that the base frame 104 can include a drive coupler 210. The drive coupler 210 provides a point of attachment where the drive will connect to the casing 202. I.e., the drive coupler 210 is where the drive and the casing 202 are attached to one another and the forces of raising the solar panel are transferred to the casing 202. As such, the drive coupler 210 must be securely attached to the casing 202, such as via welding or riveting.

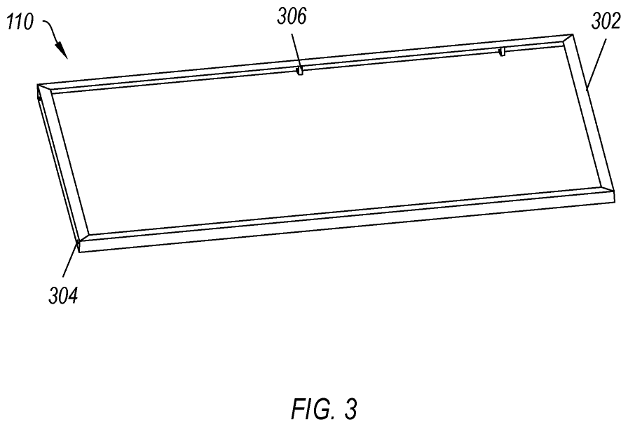

FIG. 3 illustrates an example of an inner frame 110. The inner frame 110 is configured to receive a solar panel and to be connected to a base frame. The inner frame 110 can move relative to the base frame which allows the solar panel to be tilted to maximize energy production. In addition, the inner frame 110 can fit closely with the base frame. A close fit with the base frame minimizes wind exposure because it minimizes the gap between the solar panel and the surface to which it is mounted. A close fit is achieved by an inner frame 110 which is the same shape as the base frame but has smaller dimensions.

FIG. 2 shows that the inner frame 110 can include a casing 302. The casing 302 can be a generally rectangular or approximately rectangular shape but can also be other shapes if needed to match the shape of the solar panel. The casing 302 needs to be strong but light in order to reduce the weight of the solar panel mount while being able to withstand external forces such as wind and the forces involved in tilting the panel which would tend to deform the casing 302. The casing 302 should be just slightly smaller than the casing of the base frame which allows the inner frame to at least partially withdraw into the base frame when lying flat.

FIG. 3 also shows that the inner frame 110 can include a hinge point 304. The hinge point 304 is connected to the base frame. In addition, the hinge point 304 allows the inner frame to tilt. The hinge point 304 is close to the corner, because the closer it is to the corner, the more the inner frame 110 can fit closely with the base frame. The hinge point 304 can be as simple as a hole into which a pin is inserted but it can also be any other desired hinge point.

FIG. 3 further shows that the inner frame 110 can include a drive attachment 306. The drive attachment 306 provides a point of attachment where the drive will connect to the casing 302. I.e., the drive attachment 306 is where the drive and the casing 302 are attached to one another and the forces of raising the solar panel are transferred to the casing 302. As such, the drive attachment 306 must be securely attached to the casing 302, such as via welding or riveting.

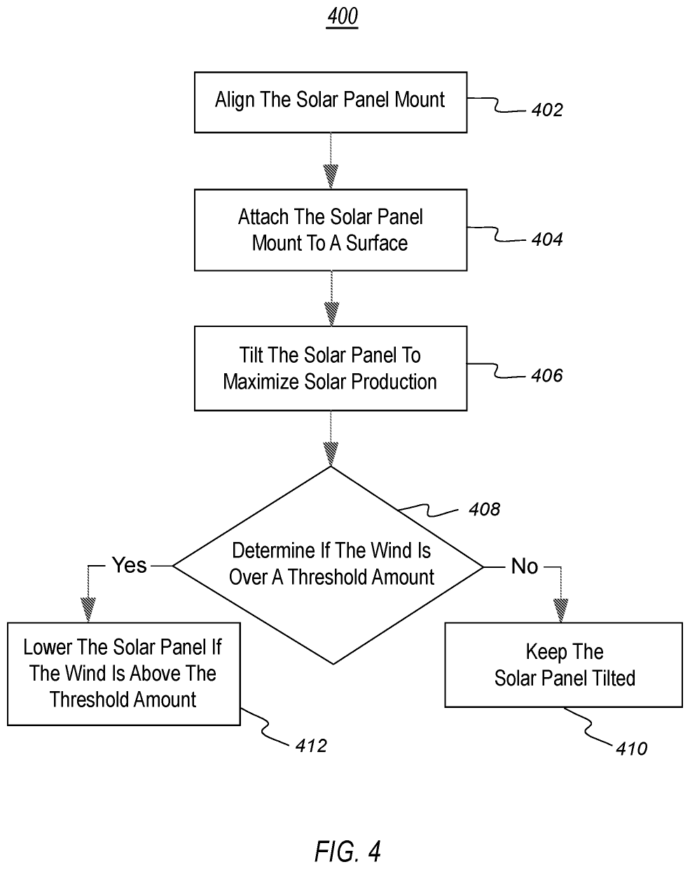

FIG. 4 is a flow chart illustrating a method 400 of maximizing solar energy production through the use of a solar panel mount. In at least one implementation, the solar panel mount can be exemplified as the solar mount 100 of FIGS. 1-3. Therefore, the method 400 will be described, exemplarily, with reference to the solar panel mount 100 of FIGS. 1-3. Nevertheless, one of skill in the art can appreciate that the method 400 can be used with solar panel mounts other than the solar panel mount 100 of FIGS. 1-3.

FIG. 4 shows that the method 400 can include aligning 402 the solar panel mount. In general, two factors are predominant in determining how to align 402 the solar panel mount. The first is the surface on which the solar panel mount will be mounted. The position of this surface may dictate a limited number of possible alignments. The second factor is the path of the sun through the sky. While the solar panel mount can be aligned 402 with the path of the sun on a particular day, the path of the sun is not the same day to day, thus alignment will be to the path of the sun on a single day.

FIG. 4 shows that the method 400 can include attaching 404 the solar panel mount to a surface. The surface can include any desired surface, such as a rooftop, a frame, the ground, etc. The solar panel mount can be attached 404 via a base frame. The base frame does not move relative to the surface. I.e., attaching 404 the base frame to the surface prevents movement of the base frame relative to the surface. The solar panel is attached 404 in the position based on the alignment 402 that was determined before mounting.

FIG. 4 further shows that the method 400 can include tilting 406 the solar panel to maximize solar production. Tilting 406 the solar panel is done on a schedule rather than based on other factors, such as a sensor. I.e., the solar panel is tilted 406 based on the anticipated location of the sun given the date and position of the solar panel.

Tilting 406 the solar panel based on a schedule simplifies the system in at least two ways. First, no sensor is needed which reduces the complexity of the mount. In particular, the solar panel may be tilted 406 based on a time schedule rather than a measured position of the sun. This allows for positioning which allows for high efficiency but completely eliminates the need for a sensor. Second, tilting 406 the sensor in multiple dimensions requires multiple drives and more complex linkages. The cost for this complexity is high, but the return in terms of increased electricity production is low. Therefore, tilting 406 the solar panel in a single direction achieves a balance between cost and benefit.

FIG. 4 additionally shows that the method 400 can include determining 408 if the wind is over a threshold amount. Determining 408 if the wind is over a threshold amount can be done in a number of ways. A sensor can measure the wind speed at the actual location of installation. Alternatively, wind measurements can be found using a database (such as a weather service database) and that measurement can be compared to the threshold amount. The wind can also be measured using indirect methods, such as the amount of force on the solar panel.

FIG. 4 moreover shows that the method can include keeping 410 the solar panel tilted when the wind is below the threshold amount. When the wind is below the threshold amount the likelihood of damage to the solar panel from wind is low or nonexistent so the solar panel is kept 410 in position where it can convert solar energy into electricity.

FIG. 4 also shows that the method 400 can include lowering 412 the solar panel if the wind is above the threshold amount. When the wind is above the threshold amount the likelihood of damage to the solar panel from wind is high so the solar panel is lowered 412 where damage from wind is less likely. Thus, energy production is maximized but potential for wind damage is minimized.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A solar panel mount, the solar panel mount comprising:
a base frame;
one or more pivots attached to the base frame;
an inner frame, wherein the inner frame is attached the one or more pivots; and
a drive, wherein the drive is configured to tilt the inner frame relative to the base frame.

2. The solar panel mount of claim 1, wherein the base frame is approximately rectangular in shape.

3. The solar panel mount of claim 2, wherein the inner frame is approximately rectangular in shape.

4. The solar panel mount of claim 1, wherein the drive includes:
a lead screw.

5. The solar panel mount of claim 1, wherein the drive includes:
a ball screw.

6. The solar panel mount of claim 1, wherein the drive includes:
a transmission.

7. The solar panel mount of claim 1, wherein the drive includes:
a transfer gears.

8. The solar panel mount of claim 1, wherein the drive includes:
a worm drive.

9. The solar panel mount of claim 1, wherein the drive includes:
a cable reel.

10. The solar panel mount of claim 1, wherein the drive includes:
a pulley system.

11. A solar panel mount, the solar panel mount comprising:
a base frame, wherein the base frame includes:
a casing, wherein the casing is approximately rectangular in shape;
one or more mounting holes in the casing, the mounting holes configured to accept a fastener;
a driver coupler, wherein the drive coupler creates a point of attachment for a drive; and
one or more pivots attached to the base frame;
an inner frame, wherein the inner frame:
is attached the one or more pivots at a hinge point; and
includes:
a casing, wherein the casing is approximately rectangular in shape; and
a drive attachment, wherein the drive attachment creates a point of attachment for the drive; and
the drive, wherein the drive is:
configured to tilt the inner frame relative to the base frame;
attached to the base frame at the drive coupler; and
attached to the inner frame at the drive attachment.

12. The solar panel mount of claim 11, wherein the base frame includes a brace, the brace connecting two opposite sides to one another.

13. The solar panel mount of claim 11, wherein the dimensions of the inner frame are smaller than the dimensions of the base frame, allowing the inner frame to nest within the base frame.

14. The solar panel mount of claim 11, wherein:
the base frame is made of aluminum; and
the inner frame is made of aluminum.

15. A method for maximizing solar energy production by using a solar panel mount, the method comprising:
aligning a solar panel mount, wherein aligning a solar panel mount includes positioning the solar panel mount within the path of the sun through the sky;
attaching the solar panel mount to a surface;
tilting the solar panel during daylight hours;
determining if the wind is over a threshold amount;
keeping the solar panel tilted if the wind is not over the threshold amount; and
lowering the solar panel if the wind is above the threshold amount.

16. The method of claim 15 wherein tilting the solar panel during daylight hours is based on a schedule of the expected position of the sun.

17. The system of claim 15 wherein tilting the solar panel is done along only a single axis.

18. The system of claim 15 wherein determining if the wind is over a threshold amount includes measuring the wind using a sensor.

19. The system of claim 15 wherein determining if the wind is over a threshold amount includes obtaining the wind speed from a database.

20. The system of claim 15 wherein determining if the wind is over a threshold amount includes measuring the forces from wind on the solar panel mount.
